(19) United States
(12) Patent Application Publication
(10) Pub. No.: US 2006/0287430 A1
(43) Pub. Date: Dec. 21, 2006

(54) MODIFYING AGENT COMPOSITION FOR POLYOLEFINS

(75) Inventors: STEPHEN E. AMOS, Minneapolis, MN (US); PATRIZIA BLASIOLI, Milan (IT)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/424,617

(22) Filed: Jun. 16, 2006

Related U.S. Application Data
(60) Provisional application No. 60/691,140, filed on Jun. 16, 2005.

(51) Int. Cl. C08L 27/12

(52) U.S. Cl. 524/544

(57) ABSTRACT

A polymer modifying agent composition, a polymer composition that uses the modifying agent composition and a method of improving the processing, physical and optical properties of a thermoplastic polymer are provided. The polymer modifying agent composition comprises a nucleating and/or clarifying agent and a dispersing agent.

### CROSS-REFERENCE TO RELATED APPLICATION

This application claims priority to U.S. Provisional Patent Application No. 60/691,140, filed Jun. 16, 2005 herein incorporated by reference in its entirety.

### FIELD OF INVENTION

This invention relates to a polymer modifying agent composition that employs a nucleating and a dispersing agent; to a melt processible thermoplastic polymer composition that utilizes this modifying agent; and to a method of improving the processing, physical and optical properties of the melt processible thermoplastic polymer.

### SUMMARY DISCUSSION

Semi-crystalline polymers, and in particular polyolefins such as polypropylene, are used in a variety of applications that require enhanced physical and optical properties. It is often desirable to substitute polypropylene for more expensive engineering plastics but the physical and optical properties of polypropylene are not sufficient for many applications. For example, engineering plastics, such as polyamides, have higher strength, higher use temperatures and increased stiffness compared to polypropylene. Other engineering plastics, such as polyester (PET), have higher clarity and lower haze compared to polypropylene.

Semi-crystalline polyolefins, such as polypropylene, have known processing parameters attributable to their rate of crystallization. To achieve a certain physical property profile it is necessary to cool at slow enough rates to allow a certain percent of crystalline or spherulitic material to form before solidification causes the crystallization process to effectively stop. Increasing the rate of crystallization or spherulite growth can enable faster cycle times in injection or blow molding operations or potentially higher extrusion process rates.

The physical and optical properties of polyolefins are largely dependent upon the degree of crystallinity that in turn is dependent on the number of nucleation sites and the rate of nucleation during the crystallization process. The nucleation step of the overall crystallization process for polyolefins, such as stabilized polypropylene, is generally slow and a relatively small number of nucleation sites are formed. These nucleation sites are the points at which spherulites start to grow during the subsequent crystallization step. Spherulites grow until they impinge upon other growing spherulites or until the melt solidifies. When spherulites are allowed to form naturally upon cooling of the melted thermoplastic the resultant percent of spherulitic material will depend upon the number of sites, cooling rate of the melt and, to a degree, any stress upon the melt that may induce spherulitic formation. The size and number of spherulites dictate the physical and optical properties of the semi-crystalline polymer.

The number of heterogeneous nucleation sites can be increased, resulting in smaller spherulites at the impingement point and yielding a higher overall percentage of crystalline material, by the addition of nucleating and/or clarifying agents. When the size of the spherulites is relatively large the visible light is scattered and the polymer article appears hazy. If an agent produces a higher degree of crystallinity (improving physical properties) but does not reduce the spherulite size below the wavelength of incident light it is generally referred to as a “nucleating agent”. If an agent produces a higher degree of crystallinity (improving physical properties) and reduces the spherulite size to where it does not interfere with incident visible light (improving optical properties) it is generally referred to as a “clarifying agent”. As a general rule it may be stated that all clarifiers nucleate but not all nucleators clarify semi-crystalline plastics. Since clarifying agents are a subset of nucleators, the term nucleator will be used as a general category herein and therefore includes clarifying agents, as a sub-class, in their entirety.

Enhanced heterogeneous nucleation raises the crystallization onset temperature of the resin. This can result in a reduced cycle time during processing and greater manufacturing efficiency.

Nucleating agents are generally known in the polymer art. Sodium benzoate and talc have been known to nucleate polypropylene, and to some degree other polyolefins. Adipic acid has been shown to nucleate polyethylenes and other polyolefins. Substituted dibenzylic sorbitol esters as described by U.S. Pat. No. 5,135,975 are common in polyolefin applications and are commercially known as the Millad™ group of products produced by Milliken Chemicals (city/state). U.S. Pat. No. 5,342,868 describes the use various organophosphorous salts produced by Asahi Denka Kogyo K.K. (city/country) and sold commercially as NA-11, as nucleators for various semi-crystalline synthetic resins. The addition of nucleating agents to achieve robust heterogeneous nucleation is not a trivial exercise. Some nucleators, depending on processing temperatures, may co-melt with the polymer and are more easily dispersed than other nucleators that do not co-melt. The afore mentioned Millad™ materials, such as Millad 3988, 3940 and 3905 as well as adipic acid are representative of potentially co-melting nucleating agents. Though these additives have good affect on physical and optical properties of polypropylene, dispersion problems resulting in the appearance of white specks have been encountered. Processing at higher temperatures may reduce speck formation but may cause other problems like instability of the polymer and increased organoleptics and color.

In the case of the phosphorous salts, talc and sodium benzoate these materials do not co-melt and dispersion is a result of the initial particle size and any pre-blending/compounding operation that may help dispersion. Sodium benzoate is particularly difficult to disperse and much expense is incurred grinding the material to a very fine particle size. This “micronized” sodium benzoate has the potential advantage of improved dispersion but suffers from handling issues associated with a low bulk density, lilting material.

More shear intensive equipment may be used to disperse both the co-melting and non-melting additives. The need to have additional, specialized equipment can add significant cost. The high shear intensity of the mixing my have deleterious effects on the polymer—instability, shear heating and oxidization, color generation.

Additionally end-users of resins (molders and extruders) may be required to purchase compounded masterbatches of nucleators where the dispersion is improved through an extra compounding step. There may also be limitations on the nucleator concentration and ability to blend nucleators with other additives in the masterbatch due to the potential to cause the additive to agglomerate. Additional processing steps can add significant cost.

There is a need in the art for nucleating agents that can be readily dispersed in semi-crystalline polymers such as polyolefins, more specifically polypropylene to improve processing, physical and optical properties without causing other problems such as organoleptics and color. The benefits of improved dispersion can also allow for more flexibility in mixing operations and with masterbatching.

As disclosed herein, it has been discovered that agents that nucleate crystal formation in semi-crystalline polymers can have improved efficiency and yield improvements on physical, processing and optical properties when combined with dispersing agents. Accordingly, the invention provides compositions comprising a semi-crystalline polymer, an effective amount of nucleating (clarifying) agent and an effective amount of dispersing agent.

The inclusion of a dispersing agent in combination with a nucleating agent provides several enhanced physical, processing and optical properties of semi-crystalline polymers with less intensive, simpler mixing processes.

### DETAILED DESCRIPTION OF THE INVENTION

Polymers suitable for use in the present invention include any semi-crystalline polymer. Non-limiting examples of semi-crystalline polymers include polyamides, polyvinylchloride, fluoropolymers, polyesters, polyolefins, poly(ethylene terephthalate) (PET), poly(butylene terephthalate) (PBT), liquid crystal polymers (LCP). Preferred semicrystalline polymers are polyolefins. Polyolefins useful in the composition of the invention include polymers and copolymers derived from one or ore olefinic monomer of the general formula CH₂═CKR″, wherein R″ is hydrogen or C₁₋₁₈ alkyl. Examples of such olefinic monomers include propylene, ethylene, and 1-butene, with propylene being generally preferred. Representative examples of polyolefins derived from such olefinic monomers include polyethylene, polypropylene, polybutene-1, poly(3-methylbutene), poly(4-methylpentene) and copolymers of ethylene and propylene, 1-butene, 1-hexene, 1=decene, 4-methyl-1-pentene, and 1-octadecene.

The polyolefin may optionally comprise a copolymer derived from an olefinic monomer and one or more further comonomers that are copolymerizable with the olefinic monomer. These comonomers can be present in the polyolefin in an amount in the range from about 1 to 10 weight percent based on the total weight of the polyolefin. Useful such comonomers include, for example, vinyl ester monomers such as vinyl acetate, vinyl propionate, vinyl butyrate, vinyl chloroacetate, vinyl chloropropianate, acrylic and alpha-alkyl acrylic acid monomers, and their alkyl esters, amides, and nitriles such as acrylic acid, methacrylic acid, ethacrylic acid, methyl acrylate, ethyl acrylate, N,N-dimethyl acrylamide, methacrylamide, acylonitrile: vinyl aryl monomers such as styriene, o-methoxystyrene, p-methoxystyrene, and vinyl naphthalene; vinyl and vinlyidene halide monomers such as vinyl chloride, vinylidene chloride, and vinylidene bromide; alkyl ester monomers of maleic and fumaric acid such as dimethyl maleate, and diethyl maleate; vinyl alkyl ether monomers such as vinyl methyl ether, vinyl ethyl ether, vinyl isobutyl ether, and 2-chlorethyl vinyl ether; vinyl pyridine monomers; N-vinyl carbazole monomers, and N-vinyl pyrrolidine monomers.

The polyolefins can also include blends of these polyolefins with other polyolefins or copolymers or blends thereof containing conventional adjuvants such as antioxidants, light stabilizers, acid neutralizers, fillers, antiblocking agents, antistatic agents, slip agents, coupling agents, and pigments.

Nucleating agents useful in the composition are benzoic acid salts such as sodium benzoate, micronized sodium benzoate, Aluminium hydroxyl-bis(4tert-butylbenzoate) (tradename: Sandostab 4030). Minerals such as talc, ground talc, CaCO₃, ground CaCO₃. Organic acids such as adipic acid and terephthalic acid. Amide derivatives of carboxylic acids such as N,N′-dicyclohexyl-2-6-napthalene dicarboxamide (tradename: NJ Star NU-100). Mono- and di-substituted sorbitol esters such as dibenzylidene sorbitol (DBS, tradenames: EC-1, Gel All D, Irgaclear D, Millad 3905), NC-5), bis(p-ethylbenzylidene) sorbitol (tradename: NC-4), bis(p-methyl-dibenzylidene sorbitol (tradename: NC-6), bis (p-methyl-dibensylidene sorbitol) (MDBS, tradenames Gel All MD, Irgaclear DM, Millad 3940), bis(3,4-dimethyl dibenzylidene sorbitol) (DMDBS, tradename: Millad 3988). Hyperform® HPN-68L (proprietary structure: Milliken Chemicals). Experimental polyethylene nucleators from Milliken called “EXP” (proprietary structure: Milliken Chemicals). Phosphate esters such as sodium 2,2′-methylene-bis(4,6-di-tert-butylphenyl)phosphate (tradename: NA-11). Those of skill in the art recognize that certain nucleating agents may fall into the category of clarifying agent as previously described herein.

Other nucleating agents suitable for use with the present invention include those structures described by patents: U.S. Pat. Nos. 5,922,793, 5,929,146, 5,981,636, 6,096,811, all herein incorporated by reference in their entirety.

In accordance with the present invention, dispersing agents are included to enhance the benefit of the nucleating agent in the semi-crystalline polymer. Non-limiting examples include block copolymers and fluoropolymers. Preferred fluoropolymer dispersing agents useful in the composition, comprise interpolymerized units derived from at lest one fluorinated, ethylenically unsaturated monomer, preferably two or more monomers, of the formula I: RCF═C(R)₂ wherein R is selected from H, F, Cl, alkyl of from 1 to 8 carbon atoms, aryl of from 1 to 8 carbon atoms, cyclic alkyl of from 1 to 10 carbon atoms, or perfluoroalkyl of from 1 to 8 carbon atoms. The R group preferably contains from 1 to 3 carbon atoms. In this monomer each R group may be different from one or more of the other R groups.

The fluoropolymers may also comprise a copolymer derived from the interpolymerization of at least one formula I monomer with at least one non-fluorinated copolymerizable comonomer having the formula II: (R1)₂C═C(R1)₂ wherein R1 is selected from H, Cl, or an alkyl group of from 1 to 8 carbon atoms, a cyclic alkyl group of from 1 to 10 carbon atoms, or an aryl group of from 1 to 8 carbon atoms. R1 preferably contains from 1 to 3 carbon atoms.

The fluoropolymers useful for this invention, as described above may be either amorphous or semi-crystalline polymers. Blends of the fluoropolymers may also be useful. Blends that create multi-modal molecular weight distributions may also be employed. Fluoropolymers with long chain branching may also be employed.

Blends of the fluoropolymers described above with synergistic coagents include but not limited to polyether polyols such as poly(oxyalkalene), silicone-polyther copolymers, aliphatic polyesters such as poly(butylenes adipate), poly(lactic acid) and polycarpolactone polyesters, aromatic polyesters, amine oxides, carboxylic acids, fatty acid esters, fatty acid amines, carboxylic acid salts such as zinc stearate, ionomers and ionomers with the acid functional group neutralized through metal salts of various types.

Block copolymers may also be utilized as dispersing agents. The block copolymers are capable of dispersing the nucleating agent in a continuous matrix of a semi-crystalline polymer. In one sense, and without intending to limit the scope of the present invention, Applicants believe that the block copolymers may act as a dispersant in order to consistently distribute the nucleating agents throughout the compatible mixture.

Preferred examples of block copolymers include di-block copolymers, tri-block copolymers, random block copolymers, graft-block copolymers, star-branched copolymers or hyper-branched copolymers. Additionally, block copolymers may have end functional groups.

Block copolymers are generally formed by sequentially polymerizing different monomers. Useful methods for forming block copolymers include, for example, anionic, cationic, coordination, and free radical polymerization methods. Non-limiting examples of block copolymers are detailed in U.S. patent application Ser. No. 11/280,924 and U.S. patent application Ser. No. 11/276,305, all of which are herein incorporated by reference in their entirety. Any amount of block copolymer may be used, however, typically the block copolymer is included in an amount in a range of up to 10% by weight.

The semi-crystalline polymer and the modifying agent described above can be made by dry blending the components together and subsequently extruding through various processes such as single screw and twin screw extrusion, internal batch mixers, batch/continuous mixing combinations, Banbury mixers, chaotic mixers. To affect dispersion the mixing device employed in these apparatuses may contain mixing elements such as pin, Maddox and pineapple mixing sections. Those of skill in the art recognize that the combination or order of addition of the components of the present invention may vary depending on specific polymers, processing conditions, processing equipment or combinations thereof.

Extruded compositions as described above may be shaped into films, extrusion blow molding articles, pipe, wire and cable extrusion, and fiber production.

Without extrusion melt processing, the composition described above may be added directly to an injection molding process. This results in the elimination of a heat-processing step. Process steps that employ heat can adversely affect the semi-crystalline polymer by causing thermal and/or oxidative degradation.

The composition described above can also be dry blended together, extruded, and then injection molded or injection blow molded into a suitable shape.

In an alternative embodiment, the dispersion agent and the nucleating agent may be incorporated into a single composition during the manufacture of either the dispersion agent or the nucleating agent.

The amount of nucleating agent used in the above composition depends on the type of nucleating material (non-melting or co-melting), availability of nucleation sites, dispersability and amount of physical, processing and optical property enhancement desired. In general the composition affords lower use level, less work in dispersion and improvement in physical properties on a same weight percent concentration basis compared to the use of nucleating agent alone. Typically nucleating agents of the classes described above are used in concentrations ranging from 0.01 up to 5% by weight. More specifically the sorbitol ester, phosphate ester, carboxylic (including benzoic) acid derivatives and materials described by U.S. Pat. Nos. 5,922,793, 5,929,146, 5,981,636, 6,096,811 are utilized in a concentration range of 0.1 to 0.5 weight percent. Talc and CaCO₃ may be used at higher levels to affect nucleation and physical property generation. Specific levels for these minerals may range from 0.5 to 5 percent by weight.

The amount of fluoropolymer in the melt-processible polymer composition is typically relatively low. The exact amount used may be varied depending upon whether the melt-processible composition is to be extruded into its final form (e.g., a pellet, sheet) or whether it is to be used as a masterbatch or processing additive which is to be further diluted with additional host polymer before being extruded into its final form. Generally, the fluoropolymer comprises from about 0.005 to 50 weight percent of the melt processible polymer composition. If the melt processible polymer composition is a masterbatch or processing additive, the amount of fluoropolymer may vary between about 2 to 50 weight percent of the composition. If the melt processible polymer composition is to be extruded into final form and is not further diluted by the addition of host polymer, it typically contains a lower concentration of fluoropolymer, e.g., about 0.005 to 2 weight percent, and preferably about 0.01 and 0.2 weight percent of the melt-processible composition. In any event, the upper concentration of fluoropolymer used is generally determined by economic limitations rather than by any adverse physical effect of the concentration of the fluoropolymer.

What is claimed is:

1. A modifying agent comprising a nucleating agent and a dispersing agent.

2. The modifying agent of claim 1, wherein the dispersing agent is a fluoropolymer.

3. The modifying agent of claim 2, wherein the dispersing agent is selected from an amorphous fluoropolymer, a semi-crystalline fluoropolymer or a long chain branched fluoropolymer.

4. The modifying agent of claim 1, wherein the dispersing agent is a multi-modal blend of fluoropolymers.

5. The modifying agent of claim 1, wherein the dispersing agent is a blend of fluoropolymer with synergistic agent.

6. The modifying agent of claim 1, wherein the dispersing agent is a block copolymer.

7. The modifying agent of claim 1, wherein the nucleating agent is selected from benzoic acid salts, minerals, organic acids, amide derivatives of carboxylic acids, mono- and di-substituted sorbitol esters, phosphate esters, or combinations thereof.

8. The modifying agent of claim 1, wherein the nucleating agent is a clarifying agent.

9. The modifying agent of claim 1, wherein the nucleating agent and dispersing agent, when incorporated into a polyolefin during melt processing, are capable of enhancing the optical properties, the physical properties or both of the solidified polymer.

10. A melt processible composition comprising a polyolefin and the modifying agent of claim 1.

11. The composition of claim 10, wherein the modifying agent is included in an amount of about 0.01 to about 5 weight percent.

12. A method comprising melt processing a semi-crystalline polymer with the modifying agent of claim 1.

13. The method of claim 12, wherein the semi-crystalline polymer is a polyolefin.

14. The method of claim 13, wherein the polyolefin is primarily a polypropylene.

15. The method of claim 12, wherein the modifying agent is included in an amount of about 0.05 to about 5 weight percent.

16. The method of claim 12, wherein processing time is reduced when compared to melt processing a polyolefin and nucleating agent without a dispersing agent.

17. A method comprising dry-blending a semi-crystalline polymer with the modifying agent of claim 1 and injection molding the composition directly without a melt compounding process step.

18. A method of claim 17, wherein the semi-crystalline polymer is a polyolefin.

19. A method of claim 18, wherein the polyolefin is primarily a polypropylene.

20. The method of claim 17, wherein the modifying agent is included in an amount of about 0.05 to about 5 weight percent.
